(19) United States
(12) Patent Application Publication
(10) Pub. No.: US 2020/0097646 A1
(43) Pub. Date: Mar. 26, 2020

(54) VIRTUALIZATION TECHNIQUES WITH REAL-TIME CONSTRAINTS

(71) Applicant: QUALCOMM Incorporated, San Diego, CA (US)

(72) Inventors: Robert Emanuel Buhren, Berlin (DE); Liang Cai, San Diego, CA (US); Can Acar, San Diego, CA (US)

(21) Appl. No.: 16/142,353

(22) Filed: Sep. 26, 2018

(51) Int. Cl. G06F 21/44; G06F 9/50

(52) U.S. Cl. CPC G06F 21/44; G06F 9/5016

(57) ABSTRACT

Techniques for managing resources on computing device are provided. An example processor according to these techniques includes a resource management module (RMM) configured to be executed by the processor as an only privileged application on the processor such that the RMM has exclusive control over the allocation of memory resources utilized by the other applications executed by the processor and assignment of access permissions to the memory resources. The RMM is configured to manage the memory resources used by other applications executed by the processor, to group applications into logical compartments, and to enforce separation between the compartments such that resources associated with one compartment are inaccessible to another compartment. The processor may include a memory protection unit (MPU) configured to provide memory protection for memory utilized by the processor, and the RMM can be configured to dynamically configure the MPU regions to enforce separation between compartments.

### BACKGROUND

A computing device may have multiple applications installed that each have different security requirements. Some applications may operate on sensitive data or incorporate intellectual property (IP) of the software vendor. System software typically relies on dynamic paging mechanisms to keep applications with different security properties separated. A memory management unit (MMU) is typically used to enforce these dynamic paging mechanisms. However, not all processors have such functionality, and the application core on such devices may not enforce any separation between the applications running on the application core or separation between system software and non-system software applications running on the application core.

The security implications of such systems can be quite severe. Every stakeholder, including but not limited to the original equipment manufacturer (OEM), the original design manufacturer (ODM), third party software providers, and the user of the device would need to mutually trust one another that sensitive data and/or IP would not be compromised by another stakeholder. A security issue with a single software component could affect the entire computing device, and software license requirements imposed by third party software vendors requiring protection from other stakeholders cannot be fulfilled in such an operating environment. Furthermore, security sensitive tasks which require a protected execution environment cannot be executed on the application core, because any other software operating on the computing device could potentially access or alter sensitive data and/or program code associated with such security sensitive tasks.

Another issue that can arise in a multicore system on a chip (SoC) is that the other cores cannot enforce access permissions on an application level. It is not possible to distinguish between requests from one application or another application once outside of the application core. Accordingly, an application may attempt to obtain access to data and/or program content that the application should not otherwise have access to by requesting the access from another processor core.

### SUMMARY

An example processor according to the disclosure includes a resource management module (RMM) configured to be executed by the processor as an only privileged application on the processor such that the RMM has exclusive control over allocation of memory resources utilized by other applications executed by the processor and assignment of access permissions to the memory resources. The RMM is configured to manage the memory resources used by other applications executed by the processor, to group applications into logical compartments, and to enforce separation between the compartments such that resources associated with one compartment are inaccessible to another compartment.

Instances of the processor can include one or more of the following features. The processor is configured to prevent software other than the RMM from executing as privileged software. One or more compartments are associated with a viewport, and the viewport is associated with policy information for managing the resources associated with the one or more compartments associated with the viewport. A compartment may be associated with more than one viewport, and the RMM is configured to isolate data associated with the compartment in one viewport from data associated with the compartment in another viewport. The processor does not include a memory management unit (MMU), but the processor includes a memory protection unit (MPU) configured to provide memory protection for memory utilized by the processor. The RRM is configured to dynamically configure the MPU regions to enforce separation between compartments. The RMM is configured to dynamically configure the MPU to enforce separation between compartments associated with different viewports based on an access control policy associated with the compartments. The RMM is configured to enforce segregation of a compartment shared by more than one viewport through virtualization of a state of the compartment and loading of a state of the compartment associated with an active viewport. The RMM is configured to detect an event indicative of a viewport switch and to switch from a currently active viewport to a viewport to be activated. The event indicative of the viewport switch comprises an external interrupt or cross-viewport communication.

An example method for operating a computing device according to the disclosure includes executing a resource management module (RMM) as a sole privileged application on a processor of the computing device such that the RMM has exclusive control over the allocation of memory resources utilized by other applications executed by the processor and the assignment of access permissions to the memory resources, executing one or more other applications on the processor at a non-privileged level, preventing the one or more other applications executed from being executed as a privileged application on the processor, and managing the memory resources used by the one or more other applications using the RMM. Managing the memory resources used by the one or more other applications further comprises grouping applications into logical compartments and enforcing separation between the compartments such that resources associated with one compartment are inaccessible to another compartment.

Instances of such a method can include one or more of the following features. One or more compartments are associated with a viewport, and the method includes managing the resources associated with the one or more compartments associated with the viewport based on policy information associated with the viewport. A respective one of the compartments is associated with a first viewport and a second viewport, and the method includes isolating data associated with the respective one of the compartments in the first viewport with data associated with the respective one of the compartments in the second viewport. The processor does not comprise a memory management unit (MMU), but the processor comprises a memory protection unit (MPU) configured to provide memory protection for memory utilized by the processor, and the method includes dynamically configuring the MPU regions to enforce separation between the compartments. Dynamically configuring the MPU regions to enforce separation between the compartments further includes dynamically configuring the MPU regions to enforce separation between compartments associated with different viewports based on an access control policy associated with the compartments. Enforcing segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active. Detecting an event indicative of a viewport switch and to switch from a first active viewport to a second viewport to be activated, the event being indicative of the viewport switch comprises an external interrupt or cross-viewport communication.

An example computing device according to the disclosure includes means for executing a resource management module (RMM) as a sole privileged application on a processing means of the computing device such that the RMM has exclusive control over allocation of memory resources utilized by other applications executed by the processing means and assignment of access permissions to the memory resources, means for executing one or more other applications on the processing means at a non-privileged level, means for preventing the one or more other applications executed from being executed as a privileged application on the processing means, and means for managing the memory resources used by the one or more other applications using the RMM. The means for managing the resource used by the one or more other applications further comprises means for grouping applications into logical compartments and enforcing separation between the compartments such that resources associated with one compartment are inaccessible to another compartment.

Implementations of such a computing device can include one or more of the following features. One or more compartments are associated with a viewport, and the computing device includes means for managing the resources associated with the one or more compartments associated with the viewport based on policy information associated with the viewport. A respective one of the compartments is associated with a first viewport and a second viewport, and the computing device includes means for isolating data associated with the respective one of the compartments in the first viewport with data associated with the respective one of the compartments in the second viewport. The processing means of the computing device does not include a memory management unit (MMU), but does include a memory protection unit (MPU) configured to provide memory protection for memory utilized by the processing means, and the computing device includes means for dynamically configuring the MPU regions to enforce separation between the compartments. The means dynamically configuring the MPU regions to enforce separation between the compartments include means for dynamically configuring the MPU regions to enforce separation between compartments associated with different viewports based on an access control policy associated with the compartments. Means for enforcing segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active. Means for detecting an event indicative of a viewport switch and to switch from a first active viewport to a second viewport to be activated, wherein the event indicative of the viewport switch comprises an external interrupt or cross-viewport communication.

An example non-transitory, computer-readable medium, having stored thereon computer-readable instructions for operating a computing device, according to the disclosure include instructions configured to cause the computing device to execute a resource management module (RMM) as a sole privileged application on a processor of the computing device such that the RMM has exclusive control over the allocation of memory resources utilized by other applications executed by the processor and the assignment of access permissions to the memory resources, execute one or more other applications on the processor at a non-privileged level, prevent the one or more other applications from being executed as a privileged application on the processor, and manage resources used by the one or more other applications using the RMM, wherein managing the resource used by the one or more other applications further comprises grouping applications into logical compartments and enforcing separation between the compartments such that resources associated with one compartment are inaccessible to another compartment.

Implementations of such a non-transitory, computer-readable medium can include one or more of the following features. One or more compartments are associated with a viewport, and the non-transitory, computer-readable medium includes instructions configured to cause the computing device to manage the resources associated with the one or more compartments associated with the viewport based on policy information associated with the viewport. A respective one of the compartments is associated with a first viewport and a second viewport, and the non-transitory, computer-readable medium includes instructions configured to cause the computing device to isolate data associated with the respective one of the compartments in the first viewport with data associated with the respective one of the compartments in the second viewport. The computing device does not comprise a memory management unit (MMU), but the computing device includes a memory protection unit (MPU) configured to provide memory protection for memory utilized by the computing device, and the non-transitory, computer-readable medium includes instructions configured to cause the computing device to dynamically configure the MPU regions to enforce separation between the compartments. The instructions configured to cause the computing device to dynamically configure the MPU regions to enforce separation between the compartments include instructions configured to cause the computing device to dynamically configure the MPU regions to enforce separation between compartments associated with different viewports based on an access control policy associated with the compartments. The non-transitory, computer-readable medium of further comprising instructions configured to cause the computing device to enforce segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active.

### BRIEF DESCRIPTION OF THE DRAWING

FIG. 1 is a functional block diagram of an example computing device that can be used to implement the techniques disclosed herein.

FIG. 2 is block diagram illustrating examples of compartments according to the disclosure.

FIG. 3 is block diagram illustrating examples of viewports according to the disclosure.

FIG. 4 is an example process for operating a computing device according to the disclosure.

FIG. 5 is an example process for operating a computing device according to the disclosure.

FIG. 6 is an example process for operating a computing device according to the disclosure.

FIG. 7 is an example process for operating a computing device according to the disclosure.

FIG. 8 is an example process for operating a computing device according to the disclosure.

FIG. 9 is an example process for operating a computing device according to the disclosure.

FIG. 10 is an example process for operating a computing device according to the disclosure.

FIG. 11 is an example process for operating a computing device according to the disclosure.

Like reference symbols in the various drawings indicate like elements, in accordance with certain example implementations.

### DETAILED DESCRIPTION

Techniques for securely operating a computing device are provided. These techniques can be used to enforce separation between applications and/or services operating on the computing device to prevent unauthorized access to sensitive data and/or valuable IP. These techniques can be used in computing device that rely on SoCs that lack an MMU or other dynamic paging mechanisms that can be used to enforce separation between applications and/or services. Such devices may be used in Internet of Things (IoT) devices that target low-power, low-latency and low-cost use cases often use a microcontroller that does not include an MMU or such dynamic paging mechanisms for maintaining separation between applications and/or services. The techniques disclosed herein remedy this problem by implementing a resource management module (RMM) configured to be executed by the processor as an only privileged application on the processor. The RMM is provided exclusive control over the allocation of memory resources utilized by other applications executed by the processor as well as the assignment of access permissions to the memory resources. This approach ensures that no application is permitted to access the memory resources associated with another application without express permission outlined in a security policy of the other application, and thus, sensitive data and/or valuable IP is protected from unauthorized access.

Many conventional SoCs are configured to distinguish between two different security domains: the kernel level and user space (also referred to as “userland”). User space refers to program code running outside of the operating system's kernel. The kernel level typically hosts program code that forms the operating system and is executed in a privileged CPU mode by the processor, whereas the user space contains unprivileged applications and/or services that are executed in a non-privileged CPU mode. Program code executed at the kernel level typically has unrestricted access to all of the underlying hardware of the computing device including executing any CPU instruction and accessing any memory address. In contrast, program code executed at the user space level has limited access to the underlying computing device and often delegates requests to access hardware and/or memory addresses through system libraries that provide an interface for access these resources.

To invoke a service provided by the operating system, an application in the user space can execute a special instruction (e.g., the supervisor call or “svc” instruction in the ARM architecture) that leads to a transition into the privileged CPU mode. The CPU continues execution at a fixed entry point of the privileged program code, services the user space request, and returns to the unprivileged application after completing the request. Each transition from one privilege level to another introduces latency overhead. In some implementations, this overhead is acceptable and application developers for such devices take this overhead into account when designing applications for such devices. However, the overhead introduced by the separation between the kernel and the user space is untenable for devices having low-latency, low-power, and low-cost requirements, such as many IoT devices. Such low-latency, low-power, and low-cost devices are typically not designed to take such overhead into account and the introduction of such overhead breaks with the current assumptions to which application designers for such devices adhere.

The techniques disclosed herein provide techniques for privilege separation that provides for the creation of protected compartments on the application core. These techniques facilitate the protection of sensitive code, such as but not limited to cryptographic operations. These techniques also confine potentially untrusted code that may attempt to access or modify sensitive data or program code in an unauthorized manner. These techniques can also prevent sensitive IP included in program code from unauthorized access by program code introduced by other stakeholders.

The techniques disclosed herein can be implemented on a processor that can support at least two privilege levels. These techniques can be implemented in processors that lack a memory management unit (MMU) but include a memory protection unit (MPU) that is configured to take privilege level into consideration when enforcing memory access rights. Unprivileged applications do not have access to the MPU. Privileged applications do have access to the MPU and can configure the memory regions of the MPU. According to the techniques disclosed herein, a resource management module (RMM) is the only privileged software component that may be executed by the processor. All other components, including the operating system of the device, are executed at an unprivileged level.

The RMM utilizes compartments and viewports to manage the security requirements associated with the unprivileged applications and/or services. A compartment is a logical grouping of components, and each component comprises a set of memory resources that form a logical entity. An application is one example of such a logical entity, and a compartment may include more than one application and/or service. An application or service can include content stored in multiple memory regions. The application or service can have data stored on a stack (“call stack” or “program stack”) data structure that stores information about active subroutines of the application. The application or service can also have memory regions dynamically allocated to the application from a portion of memory referred to as a heap. An application or service can include more data segments in addition to or instead of a stack and heap. Accordingly, references to the stack and heap made herein merely intended to illustrate the various techniques disclosed herein and the stack and heap references in the examples that follow can be replaced with other data segments in addition to or instead of the heap and stack references of the examples. A compartment can include multiple components, including one or more applications, services, and/or device memory regions. The RMM is configured to dynamically configure the MPU to allocate memory regions to each compartment of an active viewport. The MPU is configured to prevent compartments from accessing or modifying contents of memory regions not allocated to those compartments.

The compartments (and the components contained therein) operate in an unprivileged level, and thus all applications and/or services executed by the computing device, with the exception of the RMM, are executed at an unprivileged level. However, the RMM is configured to enforce policies that limit which memory locations an application or service can access. The RMM enforces policies based on viewports. A viewport is a union of active compartments. Components in compartments in the same viewport may communicate with one another. However, the RMM can limit communications between compartments in different viewports.

The RMM configures the MPU according to the currently active viewport. All applications or services executed within the viewport are executed at the same, unprivileged level, such that function calls within the viewport do not involve a change to a privileged mode. All program code executed on the computing device is executed at the same unprivileged level while the RMM operates at a privileged level. This approach can improve performance because calls to what would have otherwise been privileged program code does not require a privilege level switch to execute the code and a privilege level switch back to the calling application or service once the privileged code has been executed.

The RMM uses compartments to isolate applications, services, and/or other program code in other compartments. A compartment may be shared by more than one viewport and may be shared by two mutually distrustful viewports where the compartment only uses data of the calling compartment. This can be achieved by allocating all objects that are needed for a specific call in the caller's compartment space. This approach can increase performance and can also be used to implement thread-safe libraries.

The RMM can also be configured to handle scheduling issues that would have normally been handled by the real-time operating system (RTOS) of the device. The RTOS is de-privileged in the techniques disclosed herein and operates as part of a shared compartment that can be accessed from multiple viewports. As a result, the scheduling routine can be split into two portions: (1) a first portion executed in the current viewport and (2) a second portion executed within a target viewport. With respect to the current viewport, the RMM can be configured to save a current context of the viewport, including a context of each of the compartments that comprise the viewport and to determine whether a viewport switch is necessary based on whether a call was made to the current viewport or to another viewport. With respect to the target viewport, the RMM can be configured to restore the context of the target viewport if a viewport switch is required. The context information and other data associated with each viewport is isolated from the other viewports.

The RMM can isolate malicious software using these techniques. A malicious application controlled by an attacker in one compartment cannot influence the restoration of a target thread associated with a target compartment in a different viewport. The RMM isolates each compartment and is responsible for the restoring the context information for each compartment in response to a viewport switch. Malicious software cannot influence software outside of the container/viewport in which the malicious software is contained.

These techniques advantageously provide secure execution environments for mutually distrustful components on the same computing device. These techniques can also provide assurances to other processor cores of the same SoC about the origin of a request, since the RMM is the only privileged application that is permitted to be executed on each of the processor cores. These techniques also allow for the reuse of the existing software stack and also facilitates implementing the security architecture as an optional part of the software stack of the computing device. The examples that follow illustrate these concepts.

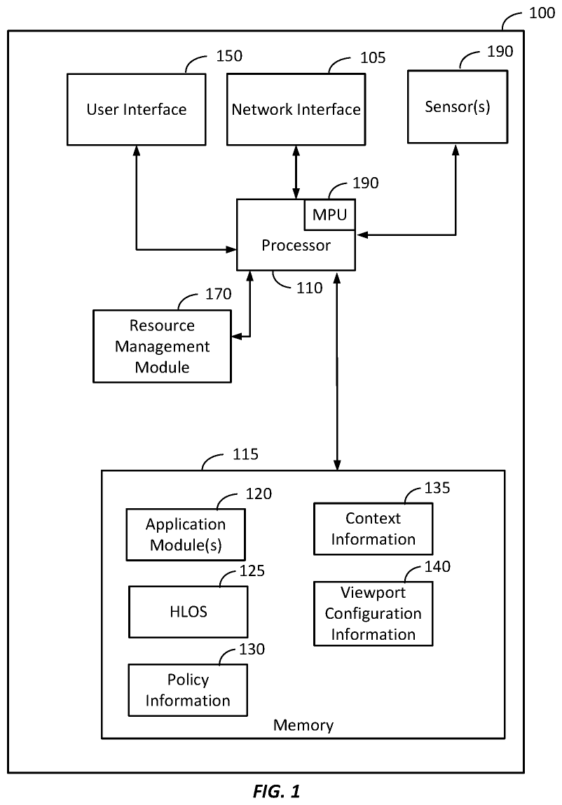

FIG. 1 is a functional block diagram of an example computing device 100 that can be used to implement various techniques disclosed herein. For the sake of simplicity, the various features/components/functions illustrated in the schematic boxes of FIG. 1 can be connected together using a common bus or are can be otherwise operatively coupled together. Other connections, mechanisms, features, functions, or the like, may be provided and adapted as necessary to operatively couple and configure a computing device 100. Furthermore, one or more of the features or functions illustrated in the example of FIG. 1 may be further subdivided, or two or more of the features or functions illustrated in FIG. 1 may be combined. Additionally, one or more of the features or functions illustrated in FIG. 1 may be excluded. Some or all of the functionality discussed with respect to computing device 100 may be implemented as a system on a chip (SoC) in which various components of a computing device are implemented on a single substrate.

As shown, the computing device 100 can include a network interface 105 that can be configured to provide wired and/or wireless network connectivity to the computing device 100. The network interface can include one or more local area network transmitters, receivers, and/or transceivers that can be connected to one or more antennas (not shown). The one or more local area network transmitters, receivers, and/or transceivers comprise suitable devices, circuits, hardware, and/or software for communicating with and/or detecting signals to/from one or more of the wireless local area network (WLAN) access points, and/or directly with other wireless computing devices within a network. The network interface 105 can also include, in some implementations, one or more wide area network transmitters, receivers, and/or transceivers that can be connected to the one or more antennas (not shown). The wide area network transmitters, receivers, and/or transceivers can comprise suitable devices, circuits, hardware, and/or software for communicating with and/or detecting signals from one or more of, for example, the wireless wide area network (WWAN) access points and/or directly with other wireless computing devices within a network. The network interface 105 can include a wired network interface in addition to one or more of the wireless network interfaces discussed above. The network interface 105 can be used to receive data from and send data to one or more other network-enabled devices via one or more intervening networks.

The processor(s) (also referred to as a controller) 110 may be connected to the memory 115, the resource management module 170, the user interface 150, and the network interface 105. The processor may include one or more microprocessors, microcontrollers, and/or digital signal processors that provide processing functions, as well as other calculation and control functionality. The controller 110 may be part of a multicore processing system. The controller 110 may be coupled to storage media (e.g., memory) 115 for storing data and software instructions for executing programmed functionality within the computing device. The memory 115 may be on-board the processor 110 (e.g., within the same integrated circuit package), and/or the memory may be external memory to the processor and functionally coupled over a data bus. The controller 110 can be implemented as a multicore system on chip (SoC) that includes the controller(s) 110 as one component of an integrated circuit that can include the memory 115, peripherals, and/or other components of the computing device 100 disposed on a substrate.

According to some implementations, the computing device 100 can be a computing device that is intended for low-power, low-latency, and/or low-cost uses and the controller 110 can be a microcontroller that that includes fewer features than fully-featured processor cores that may be utilized in other computing devices. For example, the controller 110 may be a microcontroller based on the ARMv7-M architecture versus a system on a chip (SoC) based on the ARMv8-A architecture. The controller 110 may lack features, such as dynamic paging mechanisms enforced by a memory management unit (MMU) to keep applications having different security properties separated so that one application cannot access resources and/or data associated with another process having different security properties. The controller 110 may lack such a separation mechanism, and the software stack for the application core on such microcontrollers typically do not enforce any separation between applications running on that core and/or between system software and other applications that may be executed on the computing device.

Microcontroller such as controller 110 may be used in Internet of Things (IoT) devices. IoT provides for the internetworking of various types of physical devices, such as lighting components, thermostats, heating or cooling components, switches, sensors, locks, industrial equipment, medical devices, and/or other access control devices, and/or other wirelessly-enabled devices. Various IoT protocols are being developed to handle the varying needs and functions of the myriad of IoT devices that are being developed, including but not limited to the Enhanced Machine-Type Communication (eMTC), the Narrowband Internet of Things (NB-IoT) protocols, and the Lightweight Machine-to-Machine (LwM2M) protocols. Cost and efficiency can drive manufacturers to select the microprocessors that may include less functionality. Furthermore, efficiency concerns related to power consumption and/or real-time processing and the need to reduce latency may drive manufacturers to select a microprocessor over a processor that provides mechanisms for keeping applications separated.

The controller(s) 110 can include a memory protection unit (MPU) 190. The MPU 190 is configured to provide memory protection by controlling memory access rights to prevent a process from accessing memory that has not been allocated to that process. The MPU 190 is configured to allow privileged software to define memory regions and to assign memory access permissions and memory attributes to each of the memory regions. The resource management module 170 (discussed in detail below) is the only privileged software on the computing device 100. Accordingly, the RMM 170 has exclusive control over the MPU 190. The number of support memory regions can vary depending upon the implementation of the controller(s) 110. The MPU 190 can be configured to monitor transactions writing to and reading from the memory regions. The MPU 190 can be configured to trigger a fault exception in response to an access violation being detected. An access violation can occur when a process that is unauthorized to access a particular memory region attempts to read content (e.g. data/processor-executable instructions) from the memory region or write content to the memory region. The MPU 190 can be configured to throw a fault exception to halt execution of the process that made an unauthorized access and/or to cause the computing device 100 to take other actions, such as disabling an application associated with the process and/or rebooting the computing device 100.

A number of software modules and data tables may reside in memory 115 and may be utilized by the controller 110 in order to manage, create, and/or remove content from the computing device 100 and/or perform device control functionality. Furthermore, components of the real-time operating system (“RTOS”) 125 of the computing device 100 may reside in the memory 115. As illustrated in FIG. 1, in some embodiments, the memory 115 may include an application module 120 which can implement one or more applications. It is to be noted that the functionality of the modules and/or data structures may be combined, separated, and/or be structured in different ways depending upon the implementation of the computing device 100.

The techniques disclosed herein provide a resource management module (RMM) 170 that is configured to enforce separate between applications running on the microcontroller 110. The RMM 170 is configured to provide an operating environment on the SoC that: (1) allows for the creation of protected compartments on the application core; (2) allows other processors residing on the same SoC as the controller 110 to enforce access permissions based on the application that initiated a request; and (3) does not impose a significant overhead which would limit the use of existing applications on the computing device. On a SoC that include multiple processors, the RMM is responsible for enforcing access control on applications that are running on the same processor as the RMM. However, the RMM can assist another processor of the SoC in enforcing access control by providing reliable information of the active viewport associated with an application that is communicating with the other processor.

The resource management module (RMM) 170 is an application that can be executed by the controller 110 of the computing device 100. The RMM 170 can include processor-executable instructions that may be stored in the memory 115 of the computing device 100 or may be stored in another memory of the computing device 100. The RMM 170 and the data associated with the RMM 170 may be stored in a memory that is substantially inaccessible by other applications that may be executed by the computing device 100. The controller(s) 110 of the computing device 100 can be configured to execute applications and/or services at two or more privilege levels. For example, the controller(s) 110 can be configured to execute applications at a privileged level and at a non-privileged level. Applications or services being executed at the privileged level may have access to memory regions and hardware components that are not accessible to applications being executed at the non-privileged level. Privileged applications may have access to sensitive information and/or program code of other privileged applications. However, this can be problem where the program code is provided by multiple stakeholders that may or may not respect the IP rights of other stakeholders. Privileged applications may have access to sensitive data and/or program code of other applications because the controller(s) 110 do not include an MCU. The controller(s) 110 can be configured such that the RMM 170 is the only application or service that is executed at a privileged level by the controller(s) 110.

The RMM 170 can be configured to manage resources used by other applications and/or services executed by the processor. The RMM is configured to group applications and/or services into logical compartments and to enforce separation between the compartments such that resources associated with one compartment are inaccessible to another compartment. Each compartment comprises a group of one or more components. A component is a grouping of memory resources that form a logical entity, such as an application or service. A component can comprise executable program code, static variables, a program stack, a heap, and/or other content associated with one or more applications and/or services.

The memory 115 of the computing device can include viewport configuration information 140 stored therein. The viewport configuration information 140 can identify which compartment comprise one or more viewports and the components that comprise each of these compartment. The RMM 170 can use the viewport configuration information to determine which compartments and components thereof when loading a viewport. The RMM 170 can use the information when switching between viewports to determine which compartments and components thereof need to be loaded. The viewport configuration information can include security policy information in which each application or service is statically assigned to a viewport.

The RMM 170 can be configured to facilitate switching from one viewport to another in response to certain events. For example, the RMM 170 can be configured to switch from a current viewport to another viewport in response to an application or service in the current viewport invoking a software component is another viewport. Such an invocation is typically done with an inter-process call. The RMM 170 can also be configured to switch from the current viewport to another viewport in response to an external interrupt that triggers a component in another viewport. The RMM 170 can also be configured to implement scheduling, and the RMM 170 can be configured to switch from the current viewport to another viewport as a result of scheduling.

The RMM 170 can be configured to provide access control for the contents of each compartment. Each component is associated with access policy information 130 (also referred to as security policy information). The policy information 130 can be stored in the memory 115 of the computing device. Intra-viewport communications between compartments within the same viewport are permitted. The RMM 170 is also configured to allow inter-viewport communication between compartments, but such communications are restricted and controlled by the RMM 170. The RMM 170 is configured to dynamically configure the MPU 190 of the processor 110 based on the viewport that is currently active. The RMM 170 is configured to define memory regions and assign permissions to these memory regions of the MPU 190. The RMM 170 can assign the permissions to components of each compartment based on policy information associated with each compartment. The MPU 190 prevents unauthorized memory accesses by compartments other compartments not authorized to access a particular memory region. Additional details regarding the interaction of components and viewports will be discussed in greater detail in the examples that follow.

The application module(s) 120 can comprise one or more applications and/or services that can be executed by the controller 110 of the computing device 100. The application module 120 may be a process or thread running on the controller 110 of the computing device 100, which may request data from one or more other modules (not shown) of the computing device 100. Applications typically run within an upper layer of the software architectures and may be implemented in a rich execution environment of the computing device 100 (also referred to herein as a “user space”), and may include games, shopping applications, content streaming applications, web browsers, location aware service applications, etc. However, as discussed above, the applications, real-time operating system, and other software components of the computing device 100 are executed a same non-privileged level, and the RMM 170 is the only application that operates at a privileged level on the computing device 100.

The computing device 100 may further include a user interface 150 providing suitable interface systems for outputting audio and/or visual content, and for facilitating user interaction with the computing device 100. The computing device 100 may include various user interface components, such as a keypad and/or a touchscreen for receiving user inputs, and a display (which may be separate from the touchscreen or be the touchscreen) for displaying visual content.

As further illustrated in FIG. 1, the example computing device 100 can include one or more sensors 190 coupled to a controller/processor 210. For example, the sensors 190 may include motion sensors to provide relative movement and/or orientation information for the computing device 100. By way of example but not limitation, the motion sensors may include an accelerometer, a gyroscope, and a geomagnetic (magnetometer) sensor (e.g., a compass), any of which may be implemented based on micro-electro-mechanical-system (MEMS), or based on some other technology. The one or more sensors 190 may further include, a thermometer (e.g., a thermistor), an audio sensor (e.g., a microphone) and/or other sensors. The one or more sensors 190 may also include a camera (e.g., a charge-couple device (CCD)-type camera, a CMOS-based image sensor, etc.), which may produce still or moving images (e.g., a video sequence) that may be displayed on a user interface device, such as a display or a screen, and that may be further used to determine an ambient level of illumination and/or information related to colors and existence and levels of UV and/or infra-red illumination. The sensor(s) 190 may include one or more of the examples discussed herein and may include other types of sensors not discussed herein in addition to or instead of these examples. The types of sensors included on the operating environment in which the computing device 100 is to be deployed. In one example implementation, the computing device 100 can be an IoT device can be deployed in an industrial plant to monitor various manufacturing processes and can include imaging sensors for detecting imperfections or flaws in products being produced. In another example implementation, the computing device 100 can be deployed as a sensor for monitoring conditions in remote or dangerous environments, such as monitoring volcanic activity. In such an implementation, the computing device 100 may include sensors for monitoring atmospheric gases, sensors for monitoring ground movement and/or deformation, and/or other types of sensors.

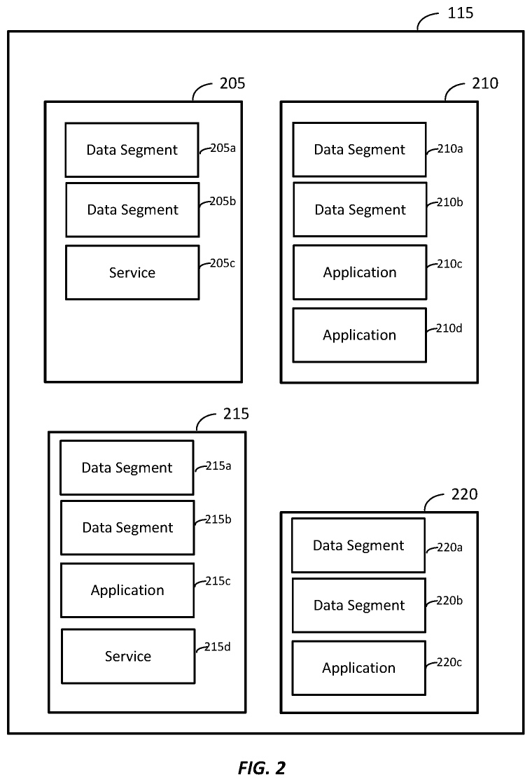

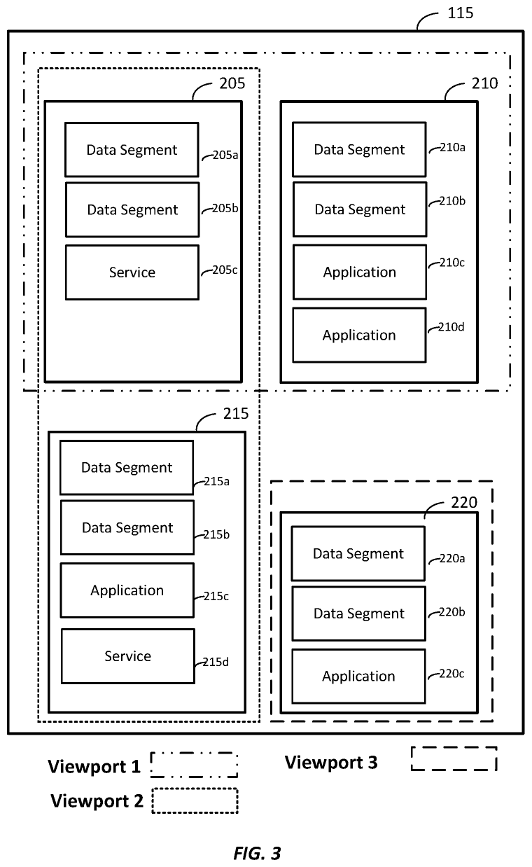

FIG. 2 is a block diagram illustrating example compartments in the memory 115 of the computing device 100. FIG. 3 is a block diagram illustrate the example compartments of FIG. 2 which have been grouped into viewports. In the example illustrated in FIGS. 2 and 3 there are four compartments 205, 210, 215, and 220 illustrated. Each compartment comprises a plurality components associated with that compartment that are numbered with the reference number associated with the respective one of the compartments with which the component is associated followed by a letter. Compartment 205 comprises components 205a, 205b, and 205c. Compartment 210 comprises components 210a, 210b, 210c, and 210d. Compartment 215 comprises components 215a, 215b, 215c, and 215d. Compartment 220 comprises components 220a, 220b, and 220c. The components of each of the respective compartments can comprise content stored in memory regions of the memory 215 and/or other memory controlled by the MPU 190. As discussed above, the components can comprise executable program instructions, static variables, a program stack, a heap, data, and/or other data associated with one or more applications and/or services that are associated with a respective one of the compartments. The data segments illustrated in the various compartments of FIG. 2 illustrate examples of such compartments. By default, the compartments can be isolated from one another. The RMM 170 can configure the MPU 190 to set up memory regions for each of the compartments, and the MPU 190 can enforce memory accesses by applications and/or services in each compartment to prevent memory accesses to memory regions allocated to other compartments.

FIG. 3 illustrates the compartments from FIG. 2, which have been grouped into three viewports. A viewport can include one or more components. The viewports illustrated in FIG. 3 are represented by boxes with broken/dotted lines. Viewport 1 includes compartments 205 and 210. Viewport 2 includes compartments 205 and 215. Viewport 3 includes only compartment 220. Only one viewport can be active on the computing device 100 at a time, and the data and contents of each viewport is segregated from the other by the RMM 170.

The RMM 170 is configured to allow communication between compartments that are within the same viewport. For example, when viewport 1 is active, the RMM 170 can permit the service associated with compartment 205 to communicate with an application of compartment 210 or vice versa. Similarly, when viewport 2 is active, the RMM 170 can permit the service associated with compartment 205 to communicate with an application or service of compartment 215 or vice versa. Viewport 3 only includes component 220 so no intra-viewport communications are possible within component 220. The viewport configuration information 140 stored in the memory 115 of the computing device 100 can indicate which viewports include which compartments and which components are included in each of the compartments. The viewport configuration information 140 can include information defining more than one viewport. However, only one viewport may be active on the computing device 100 at a time.

The viewports can also be associated with access policy information 130, which can include information regarding which components may be included in the same viewport. The access policy information 130 can also indicate which compartments can call functions of components of another compartment, which compartments can share access to certain memory regions and which memory regions of compartments cannot be shared. The association between a viewport and the one or more compartments is defined in the viewport configuration information 140. However, additional viewports may be defined that may include different combinations of compartments, so long as the access policy information 130 indicates that the compartments added to the viewport are permitted to be added to the same viewport.

By default, the RMM 170 can be configured to prevent inter-viewport communications in order to isolate each viewport from one another. For example, the RMM 170 can be configured to prevent an application of one of the compartments of viewport 1 from attempting to call an application or service of one of the compartments of viewport 2 or viewport 3 by default. However, the access policy information 130 can be configured to allow such inter-viewport communications. The RMM 170 can be configured to virtualize any shared compartments that are used by the viewports so that no leakage or manipulation of sensitive data or program code between the viewports can occur.

The RMM 170 is configured to handle viewport switching. Only one viewport can be active at a time. However, certain events can prompt the RMM 170 to switch from one active viewport to another. For example, certain viewports can be configured to allow inter-viewport communications with other specified viewports. The RMM 170 can be configured to recognize a function call by a compartment of a first viewport (e.g., viewport 1 from FIG. 2) to a compartment of a second viewport (e.g., viewport 2 from FIG. 2). For example, a first application or service of the compartment of the first viewport may not be permitted to be included in the same viewport as a second application or service of a compartment of the second viewport. The two applications or services may, for example, be required to be included in separate viewports due to licensing constraints by the software vendors associated with these applications or services that require the applications or services to be isolated from other applications or services to prevent sensitive data and/or program code from the application from being leaked to other applications. However, the first application or service may be permitted by the access policy information 130 to call one or more functions of the second application or service in order to have the second application or service perform one or more operations on behalf of the first application or service. In response to the function call by the first application or service, the RMM 170 can verify that the function call is permitted based on the access policy information 130 and can execute a viewport switch from the first viewport to the second viewport. The RMM 170 can be configured to store context information 135 for each of the compartments of the first viewport that represents a current state of each of the compartments. The context information 135 can be stored in the memory 115 of the computing device and/or in another memory location. The RMM 170 can be configured to notify each of the compartments that a viewport switch is being undertaken so that the each of the compartments can be placed in a state where the viewport switch will not cause any data loss. Once the context information 135 for the first viewport has been saved, the RMM 170 can terminate any processes associated with the first viewport and can initialize execution of the second viewport. The RMM 170 can load context information 135 for the second viewport from the memory 115 (if any) and begin execution of the second viewport. The RMM 170 can save the context information 135 associated with the second viewport to the memory 115 after the application or service associated with the second viewport has completed executing the requested function, access the context information 135 associated with the first viewport, and resume execution of the first viewport.

The RMM 170 can also be configured to switch between viewports in response to an interrupt. The RMM 170 can be configured to serve as an interrupt handler for interrupts that occur while the RMM 170 is managing an active viewport. The RMM 170 can be configured to respond to hardware interrupts from one or more sensors, user interface hardware components (e.g. a touchscreen, button, keyboard, keypad, or other user interface hardware), or other hardware components of the computing device 100 that require a switch from a current viewport to another viewport. The RMM 170 can also be configured to handle software interrupts that indicate a need to switch from a currently active viewport to another viewport.

The RMM 170 effectively replaces the scheduler of the RTOS by handling viewport switching in response to inter-viewport calls and interrupts. Each viewport can include multiple active components, and the RMM 170 can be configured to handling scheduling within the active viewport by monitoring which processes associated with the viewport are ready to be executed, suspending an active process (if any), and executing a next process to be executed.

The RMM 170 can be configured to permit a container to be associated with more than one viewport through virtualization. For example, viewport 1 and viewport 2 illustrated in FIG. 3 both include container 205. In order to ensure that data is not leaked from the viewport 1 to viewport 2 or vice versa, the state of the container 205 is virtualized for viewport 1 and viewport 2. In the event of a context switch from viewport 1 to viewport 2, the context of container 205 will be stored with the rest of context information 135 is stored for viewport 1. A separate instance of container 205 will be instantiated for viewport 2. Context information 135 for container 205 that is included in the context information 135 for viewport 2 can be accessed (if any), and the container 205 instance associated with viewport 2 can be instantiated. By virtualizing the shared containers, no information leakage between the viewports occurs. Furthermore, the container 205 is made thread safe by the approach. Multiple instances of the container 205 can be in use by multiple viewports on the computing device 100 without any danger of unwanted interaction between the instances of the container 205.

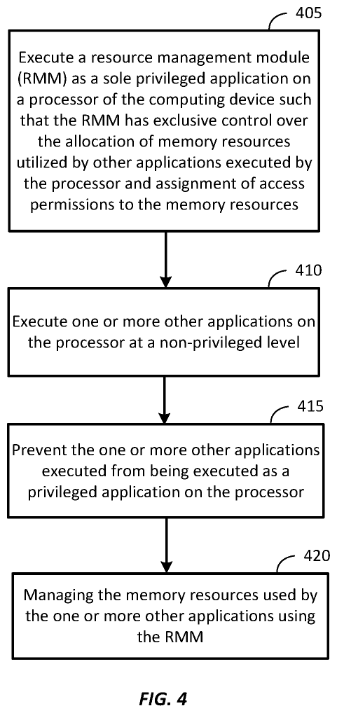

FIG. 4 is an example process for operating a computing device according to the disclosure. The process illustrated in FIG. 4 can be implemented by the resource management module 170 illustrated in FIG. 1.

A resource management module (RMM) can be executed as a sole privileged application on a processor of a computing device such that the RMM has exclusive control over the allocation of memory resources utilized by other applications executed by the processor and exclusive control over the assignment of access permissions to the memory resources (stage 405). As discussed above, the RMM 170 can be executed by the controller 190 of the computing device 100 as the only application to be executed at a privileged level on the controller 110. Because the RMM 170 is executed at a privileged level, the RMM 170 can configure the MPU 190 of the controller 110 to set up memory regions of the MPU 190 and to set up the access controls for those memory regions.

One or more other applications or services can be executed on the processor at a non-privileged level (stage 410). Other applications or services executed by the controller 110 are all executed at the same non-privileged level. The other applications or services can include the real-time operating system (RTOS) of the device and/or other components of the computing device 100 that may typically have been executed as a privileged operating system. However, by running software components of the computing device 100 within compartments within a viewport can protect sensitive information and/or program code of these software components. Applications and services are isolated within a container and cannot obtain access to intellectual property of other software vendors by accessing the program code of the applications or services provided by the other software vendors. Furthermore, attackers who manage to install a malicious application on the computing device 100 will be unable to utilize the malicious application to access and/or obtain sensitive information and/or program code of other applications on the computing device 100.

The one or more other applications or services can be prevented from being executed as a privileged application on the processor (stage 415). The controller 110 can be configured to prevent other applications or services, such as those of the application module(s) 120 from being executed at privileged level on the controller 110. Preventing the other applications or services from running at a privileged level prevents the other applications from circumventing the RMM 170 and the compartmentalization of the applications associated with each of the viewports. All applications or services are compartmentalized with one or more applications and/or services per compartment. A malicious application or service that may otherwise have attempting to access or modify sensitive data and/or program code associated with other applications or services on the computing device 100 will be unable to access or modify sensitive data and/or program code outside of the compartment in which the application is running. Furthermore, compartments that are shared by more than one viewport are virtualized by the RMM 170 so that each viewport is operating on a separate copy of the compartment and cannot access or modify compartment contents that are utilized by another viewport.

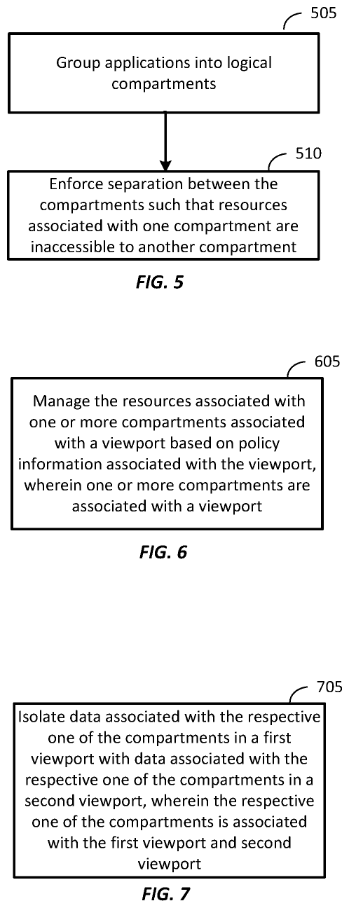

Resources used by the one or more applications or services can be managed using the resource management module (stage 420). The RMM 170 is configured to isolate one or more applications in one or more compartment associated with a currently active viewport. As discussed above, the RMM 170 is the only privileged application operating on the controller 110, which enables the RMM 170 to dynamically configure to MPU 190 of the controller 110. The RMM 170 can configure the MPU 190 according to viewport configuration information 140 stored in the memory 115 of the computing device 100. FIG. 5 is an example process that can be used to implement stage 420 of the process of FIG. 4.

FIG. 5 is an example process for operating a computing device according to the disclosure. The process illustrated in FIG. 5 can be implemented by the resource management module 170 illustrated in FIG. 1. The process illustrated in FIG. 5 can be used to implement, at least in part, stage 420 of the process illustrated in FIG. 4.

Applications and/or services can be grouped into logical compartments (stage 505). The RMM 170 is configured to group one or more applications and/or services into compartments. The RMM 170 can be configured to load viewport configuration information 140 from the memory 115. The viewport configuration information 140 can include information that identifies which components are included in the compartments the comprise the viewport.

Separation between the compartments can be enforced such that resources associated with one compartment are inaccessible to another compartment (stage 510). As discussed above, the RMM 170 can configure the MPU 190 of the controller 110 to allocate one or more memory regions to each of the compartments associated with an active viewport. If an application or service from a first compartment attempts to access memory associated with a second compartment, the MPU 190 can be configured to trigger a fault exception in response to the access violation. The RMM 170 can be configured to respond to the exception by terminating the processes associated with the compartment from which the access violation originated. The RMM 170 can also be configured to perform other exception handling instead of or in addition to shutting terminating the processes associated with the compart. The RMM 170 may shut down all active compartments of the viewport.

FIG. 6 is an example process for operating a computing device according to the disclosure. The process illustrated in FIG. 6 can be implemented by the resource management module 170 illustrated in FIG. 1. The process illustrated in FIG. 6 can be used to implement, at least in part, stage 420 of the process illustrated in FIG. 4.

Resources associated with one or more compartments associated with a viewport can be managed based on policy information associated with the viewport, wherein one or more compartments are associated with a viewport (stage 605). The RMM 170 can be configured to access viewport configuration information 140 that is stored in the memory 115 of the computing device 100 and/or in another memory location of the computing device 100. The viewport configuration information 140 can be stored in a location that is inaccessible to non-privileged applications and/or services operating on the computing device 100, so that only the RMM 170 has access to the viewport configuration information 140. The viewport configuration information 140 can include information that indicates which compartments are included in a particular viewport and the components that are included in each of the compartments. The viewport configuration information 140 can also include information that identifies what information can be shared between specific compartments of the viewport. For example, certain viewports may both be allocated access to a particular memory region where data that is produced or used by the compartments is stored. The RMM 170 can configure the MPU to allow components from these compartments to access and/or update the contents of the shared memory region while allocating other memory regions to each of the compartments that can only be accessed by the compartment to which the memory regions are allocated.

FIG. 7 is an example process for operating a computing device according to the disclosure. The process illustrated in FIG. 7 can be implemented by the resource management module 170 illustrated in FIG. 1. The process illustrated in FIG. 7 can be used to implement, at least in part, stage 420 of the process illustrated in FIG. 4.

Data associated with the respective one of the compartments in a first viewport is isolated from data associated with the respective one of the compartments in a second viewport, wherein the respective one of the compartments is associated with the first viewport and second viewport (stage 705). The RMM 170 allows the same compartment to be associated with multiple viewports. However, the shared compartment is completely virtualized by the RMM 170 to prevent malicious software included in one viewport from manipulating a compartment that is shared with another viewport. The discussion of the examples illustrated in FIGS. 2 and 3 includes an example of such virtualization.

FIG. 8 is an example process for operating a computing device according to the disclosure. The process illustrated in FIG. 8 can be implemented by the resource management module 170 illustrated in FIG. 1. The process illustrated in FIG. 8 can be used to implement, at least in part, stage 420 of the process illustrated in FIG. 4.

Memory Protection Unit (MPU) regions can be dynamically configured to enforce separation between the compartments (stage 810). In some implementations, the controller 110 may not include memory management unit (MMU) but does include an MPU 190 configured to provide memory protection for memory utilized by the controller 110. As discussed in the preceding examples, the RMM 170 is the only privileged application on the computing device 100, which gives the RMM 170 exclusive control over the memory regions allocated by the MPU 190. Each compartment is allocated one or more memory regions by the RMM 170. Some memory regions may be shared by more than one compartment depending on the viewport configuration information 140 associated with the viewport in which the compartment is associated.

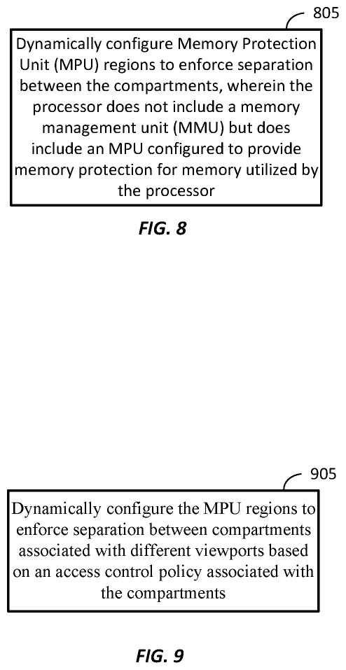

FIG. 9 is an example process for operating a computing device according to the disclosure. The process illustrated in FIG. 9 can be implemented by the resource management module 170 illustrated in FIG. 1. The process illustrated in FIG. 9 can be used to implement, at least in part, stage 805 of the process illustrated in FIG. 8.

Memory Protection Unit (MPU) regions can be dynamically configured to enforce separation between the compartments associated with different viewports based on an access control policy associated with the compartments (stage 910). As discussed in the preceding examples, the RMM 170 is the only privileged application on the computing device 100, which gives the RMM 170 exclusive control over the memory regions allocated by the MPU 190. Only one viewport can be active on the controller 110, and the RMM 170 can configure the memory regions of the MPU 190 according to the active viewport. The MPU 190 prevents processes from accessing memory that have not been allocated to that process. Accordingly, the MPU 190 can prevent an application or service from a first container from accessing memory allocated to a second container if the components of the first container are not permitted to access the memory allocated to the second container. The RMM 170 can use viewport configuration information 140 stored in the memory 115 of the computing device to determine how the MPU 190 memory regions should be configured and which memory regions can be shared by more than one container of the active viewport.

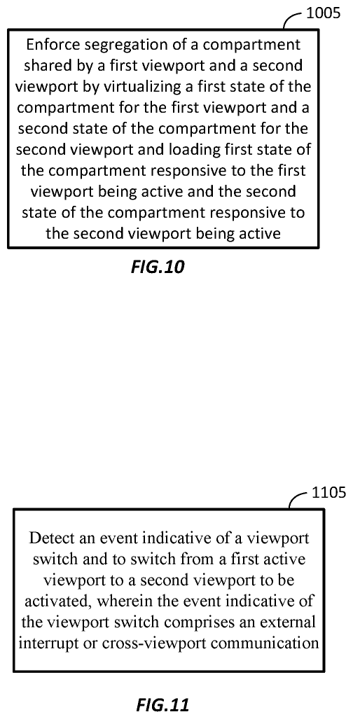

FIG. 10 is an example process for operating a computing device according to the disclosure. The process illustrated in FIG. 10 can be implemented by the resource management module 170 illustrated in FIG. 1. The process illustrated in FIG. 10 can be used to implement, at least in part, stage 805 of the process illustrated in FIG. 8.

Segregation of a compartment shared by a first viewport and a second viewport can be enforced by virtualizing a first state of the compartment for the first viewport and a second state of the compartment for the second viewport and loading first state of the compartment responsive to the first viewport being active and the second state of the compartment responsive to the second viewport being active (stage 1010). As discussed above, the RMM 170 can be configured to allow a compartment to be shared by more than one viewport, but in order to ensure that one viewport cannot interfere with another viewport by manipulating a shared compartment, the share compartment is virtualized by the RMM 170 so that each viewport operates on a separate instance of the compartment. The RMM 170 can store context information 135 for the viewport and each of the compartments associated with the viewport before switching to another viewport. The RMM 170 can access the context information 135 and use it to restore the state of the viewport when the viewport becomes active again. For shared compartments, the context information 135 associated with an instance of the compartment in a first viewport is separate from the context information 135 associated with the instance of the compartment in a second viewport.

FIG. 11 is an example process for operating a computing device according to the disclosure. The process illustrated in FIG. 11 can be implemented by the resource management module 170 illustrated in FIG. 1. The process illustrated in FIG. 11 can be used to implement, at least in part, stage 805 of the process illustrated in FIG. 8.

An event indicative of a viewport switch can be detected and a switch from a first active viewport to a second viewport to be activated can be made (stage 1110). The event can be an external interrupt, a cross-viewport communication, or other event indicative of that a switch from the first active viewport to the second viewport is necessary. As discussed above, the RMM 170 can be configured to response to external interrupts and/or cross-viewport communications by storing context information 135 representing a current state of the active viewport including information associated with each of the compartments of the viewport. The RMM 170 can then load viewport configuration information 140 for the viewport to be activated. The viewport configuration information 140 can be stored in the memory 115 of the computing device 100. The viewport configuration information 140 includes information that identifies which compartments are associated with the viewport to be active. Context information 135 may also be stored in the memory 115 if the viewport to be activated was previously active. The context information 135 can be used to return the compartments of the viewport back to their respective previous states.

If implemented in-part by hardware or firmware along with software, the functions can be stored as one or more instructions or code on a computer-readable medium. Examples include computer-readable media encoded with a data structure and computer-readable media encoded with a computer program. Computer-readable media includes physical computer storage media. A storage medium can be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and can be based on one or more items and/or conditions in addition to the stated item or condition.

What is claimed is:

1. A processor comprising:
a resource management module (RMM) configured to be executed by the processor as an only privileged application on the processor such that the RMM has exclusive control over allocation of memory resources utilized by other applications executed by the processor and assignment of access permissions to the memory resources, wherein the RMM is configured to manage the memory resources used by the other applications executed by the processor, and wherein the RMM is configured to group applications into logical compartments and to enforce separation between the compartments such that resources associated with one compartment are inaccessible to another compartment.

2. The processor of claim 1, wherein the processor is configured to prevent software other than the RMM from executing as privileged software.

3. The processor of claim 1, wherein one or more compartments are associated with a viewport, and wherein the viewport is associated with policy information for managing the resources associated with the one or more compartments associated with the viewport.

4. The processor of claim 3, wherein a compartment may be associated with more than one viewport, and wherein the RMM is configured to isolate data associated with the compartment in one viewport from data associated with the compartment in another viewport.

5. The processor of claim 1, wherein the processor does not comprise a memory management unit (MMU), and wherein the processor comprises a memory protection unit (MPU) configured to provide memory protection for memory utilized by the processor.

6. The processor of claim 5, wherein the RRM is configured to dynamically configure the MPU regions to enforce separation between compartments.

7. The processor of claim 6, wherein the RMM is configured to dynamically configure the MPU to enforce separation between compartments associated with different viewports based on an access control policy associated with the compartments.

8. The processor of claim 6, wherein the RMM is configured to enforce segregation of a compartment shared by more than one viewport through virtualization of a state of the compartment and loading of a state of the compartment associated with an active viewport.

9. The processor of claim 6, wherein the RMM is configured to detect an event indicative of a viewport switch and to switch from a currently active viewport to a viewport to be activated.

10. The processor of claim 7, wherein the event indicative of the viewport switch comprises an external interrupt or cross-viewport communication.

11. A method for operating a computing device comprising:
executing a resource management module (RMM) as a sole privileged application on a processor of the computing device such that the RMM has exclusive control over allocation of memory resources utilized by other applications executed by the processor and assignment of access permissions to the memory resources;
executing one or more other applications on the processor at a non-privileged level;
preventing the one or more other applications executed from being executed as a privileged application on the processor; and
managing the memory resources used by the one or more other applications using the RMM, wherein managing the resources used by the one or more other applications further comprises grouping applications into logical compartments and enforcing separation between the compartments such that resources associated with one compartment are inaccessible to another compartment.

12. The method of claim 11, wherein one or more compartments are associated with a viewport, the method further comprising:
managing the resources associated with the one or more compartments associated with the viewport based on policy information associated with the viewport.

13. The method of claim 12, wherein a respective one of the compartments is associated with a first viewport and a second viewport, the method further comprising:
isolating data associated with the respective one of the compartments in the first viewport with data associated with the respective one of the compartments in the second viewport.

14. The method of claim 11, wherein the processor does not comprise a memory management unit (MMU), and wherein the processor comprises a memory protection unit (MPU) configured to provide memory protection for memory utilized by the processor, the method further comprising:
dynamically configuring the MPU regions to enforce separation between the compartments.

15. The method of claim 14, wherein dynamically configuring the MPU regions to enforce separation between the compartments further comprises:
dynamically configuring the MPU regions to enforce separation between compartments associated with different viewports based on an access control policy associated with the compartments.

16. The method of claim 14, further comprising:
enforcing segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active.

17. The method of claim 14, further comprising:
detecting an event indicative of a viewport switch and to switch from a first active viewport to a second viewport to be activated, wherein the event indicative of the viewport switch comprises an external interrupt or cross-viewport communication.

18. A computing device comprising:
means for executing a resource management module (RMM) as a sole privileged application on a processing means of the computing device such that the RMM has exclusive control over allocation of memory resources utilized by other applications executed by the processing means and assignment of access permissions to the memory resources;
means for executing one or more other applications on the processing means at a non-privileged level;
means for preventing the one or more other applications executed from being executed as a privileged application on the processing means; and
means for managing the memory resources used by the one or more other applications using the RMM, wherein the means for managing the resources used by the one or more other applications further comprises means for grouping applications into logical compartments and enforcing separation between the compartments such that resources associated with one compartment are inaccessible to another compartment.

19. The computing device of claim 18, wherein one or more compartments are associated with a viewport, the computing device further comprising:
means for managing the resources associated with the one or more compartments associated with the viewport based on policy information associated with the viewport.

20. The computing device of claim 19, wherein a respective one of the compartments is associated with a first viewport and a second viewport, the computing device further comprising:
means for isolating data associated with the respective one of the compartments in the first viewport with data associated with the respective one of the compartments in the second viewport.

21. The computing device of claim 18, wherein the processing means of the computing device does not comprise a memory management unit (MMU), and wherein the processing means comprises a memory protection unit (MPU) configured to provide memory protection for memory utilized by the processing means, the computing device further comprising:
means for dynamically configuring the MPU regions to enforce separation between the compartments.

22. The computing device of claim 21, wherein the means dynamically configuring the MPU regions to enforce separation between the compartments further comprises:
means for dynamically configuring the MPU regions to enforce separation between compartments associated with different viewports based on an access control policy associated with the compartments.

23. The computing device of claim 21, further comprising:
means for enforcing segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active.

24. The computing device of claim 21, further comprising:
means for detecting an event indicative of a viewport switch and to switch from a first active viewport to a second viewport to be activated, wherein the event indicative of the viewport switch comprises an external interrupt or cross-viewport communication.

25. A non-transitory, computer-readable medium, having stored thereon computer-readable instructions for operating a computing device, comprising instructions configured to cause the computing device to:
execute a resource management module (RMM) as a sole privileged application on a processor of the computing device such that the RMM has exclusive control over allocation of memory resources utilized by other applications executed by the processor and assignment of access permissions to the memory resources;
execute one or more other applications on the processor at a non-privileged level;
prevent the one or more other applications from being executed as a privileged application on the processor; and
manage the memory resources used by the one or more other applications using the RMM, wherein the instructions configured to cause the computing device to manage the resources used by the one or more other applications further comprises instructions configured to cause the computing device to group applications into logical compartments and enforcing separation between the compartments such that resources associated with one compartment are inaccessible to another compartment.

26. The non-transitory, computer-readable medium of claim 25, wherein one or more compartments are associated with a viewport, the non-transitory, computer-readable medium further comprising instructions configured to cause the computing device to:
manage the resources associated with the one or more compartments associated with the viewport based on policy information associated with the viewport.

27. The non-transitory, computer-readable medium of claim 26, wherein a respective one of the compartments is associated with a first viewport and a second viewport, the non-transitory, computer-readable medium further comprising instructions configured to cause the computing device to:
isolate data associated with the respective one of the compartments in the first viewport with data associated with the respective one of the compartments in the second viewport.

28. The non-transitory, computer-readable medium of claim 25, wherein the computing device does not comprise a memory management unit (MMU), and wherein the computing device comprises a memory protection unit (MPU) configured to provide memory protection for memory utilized by the computing device, the non-transitory, computer-readable medium further comprising instruction configured to cause the computing device to:
dynamically configure the MPU regions to enforce separation between the compartments.

29. The non-transitory, computer-readable medium of claim 28, wherein the instructions configured to cause the computing device to dynamically configure the MPU regions to enforce separation between the compartments further comprise instructions configured to cause the computing device to:
dynamically configure the MPU regions to enforce separation between compartments associated with different viewports based on an access control policy associated with the compartments.

30. The non-transitory, computer-readable medium of claim 28, further comprising instructions configured to cause the computing device to:
enforce segregation of a compartment shared by a first viewport and a second viewport by virtualizing a first state of the compartment for the first viewport and a second state of the compartment for the second viewport and loading first state of the compartment responsive to the first viewport being active and the second state of the compartment responsive to the second viewport being active.
